(19) United States
(12) Patent Application Publication
(10) Pub. No.: US 2003/0003948 A1
(43) Pub. Date: Jan. 2, 2003

(54) Mobile terminal device and power supply device thereof

(75) Inventor: Hiroyuki Dai, Musashino-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/183,628

(22) Filed: Jun. 28, 2002

(30) Foreign Application Priority Data
Jun. 28, 2001 (JP) 2001-196611

(51) Int. Cl. H04B 1/38; H04B 1/00

(52) U.S. Cl. 455/550; 343/702; 455/129

(57) ABSTRACT

In a mobile terminal device, an antenna holder for supporting an antenna is mounted on a casing by a holder fitting tightened with the antenna holder. The antenna holder is formed of a non-metal material, and the holder fitting is formed of a non-metal material. A signal-feeding member is supported at the holder fitting, and a signal is supplied via the signal-feeding member to the antenna from a signal-feeding circuit provided on a printed circuit board. Further, the upper outside section of the antenna holder is formed of a non-metal material, and the inside section thereof is formed of a metal material. The holder fitting is formed of a non-metal material, and the signal-feeding member is supported to the holder fitting. Then, the signal is fed to the antenna from the signal-feeding circuit through the signal-feeding member.

### CROSS-REFERENCE TO RELATED APPLICATIONS

This application is based upon and claims the benefit of priority from the prior Japanese Patent Application No. 2001-196611, filed Jun. 28, 2001, the entire contents of which are incorporated herein by reference.

### BACKGROUND OF THE INVENTION

1. Field of the Invention

The present invention relates to a mobile terminal device such as a mobile phone or a PHS terminal and a signal-feeding device of the terminal, and more particularly, to a structure for supporting a retractable antenna on a casing of the mobile terminal device.

2. Description of the Related Art

In general, a mobile phone serving as a mobile terminal device has an appearance shown in FIG. 1. A mobile phone T shown in FIG. 1 is provided with a retractable or extendable antenna A. This antenna A has a structure in which the antenna can be retracted in a casing C and can be extended from the casing C.

This retractable antenna A, as shown in FIG. 2A showing a state in which the antenna is retracted, is such that, at its top part, an antenna cap Ab having a helical section Aa housed therein is exposed to the outside, and a sleeve Ac serving as a first contact point is extended coaxially with the antenna cap Ab, from the antenna cap Ab into the casing C. A flexible tube Ae is extended from the sleeve Ac, and an antenna element Ad is installed in the tube Ae. As shown in FIG. 2B showing a state in which the antenna is extended, a stopper Af serving as a second contact point is provided at the tube Ae. An antenna holder H is fixed to the casing C, and the sleeve Ac and stopper Af are slidably held on this antenna holder alternately. Therefore, the retractable antenna A is extended from the casing, and is retracted in the casing C. Then, the retracted antenna is supported by the antenna holder H.

The antenna holder H is a cylindrical member through which the retractable antenna A is inserted, and is made of a metal material having electrical conductivity. This antenna holder H is made of a metal material having electrical conductivity similarly, is screwed in a fixing nut N fixed to the inside of the casing C, and is fixed to the casing C. With such a structure, the retractable antenna A is supported by the casing C.

On the other hand, a coupling spring member E for feeding a radio frequency signal to the retractable antenna A is mounted on a circuit board B installed inside of the casing C, and this coupling spring member E is brought into contact with the above fixing nut N. Electrical components forming an electric circuit such as transmitting/receiving circuit for performing a wireless communication and a signal-modulating/demodulating are packaged on the circuit board B.

In the mobile phone T having the above antenna structure, as shown in FIG. 2A, while the retractable antenna A is housed in the casing C, the sleeve Ac is engaged with the antenna holder H. In this configuration, a high frequency signal, i.e., a radio frequency signal is fed (hereinafter, simply referred to as “signal feeding”) from the sleeve Ac of the retractable antenna A to the helical section As via the coupling spring member E, fixing nut N, and antenna holder H through the circuit board B.

On the other hand, while the retractable antenna A shown in FIG. 2B is extended from the casing C, the stopper Af is engaged with the antenna holder H. In this manner, a radio frequency signal is supplied from the stopper Af of the retractable antenna A to the element Ad via the coupling spring member E, fixing nut N, and antenna holder H through the circuit board B.

In the meantime, in the above conventional mobile phone T, the fixing nut N and antenna holder H, both of which are formed of a metal material and are tightened with each other, are interposed in a signal feeding path from the circuit board B to the retractable antenna A. Therefore, in the case where the retractable antenna A is retracted or extended, impedance matching changed due to a capacity between the above antenna holder H and fixing nut N, a transmission signal loss in the retractable antenna A increases. Thus, there is a problem that predetermined performance cannot be achieved with respect to transmission characteristics or the like in the retractable antenna A.

In order to eliminate such an inconvenience, at the stage of fabrication, complicated adjustment works are required for ensuring the predetermined performance in the retractable antenna A such as adjusting the length of the helical section Ac in the retractable antenna A or decreasing the capacity of the antenna holder H or nut N that is a block of a metal material. Thus, there is a problem that the development period for the mobile terminal may be prolonged.

In addition, in the above conventional mobile phone T, a plurality of members coming into contact with each other, such as the coupling spring member E, fixing nut N, or antenna holder H are interposed in a signal feeding path from the circuit board B to the retractable antenna A. Thus, in the case where a contact state between the coupling spring member E and the fixing nut N or between fixing nut N and the antenna holder H changes, the characteristics of the retractable antenna A changes as well. Therefore, there is an inconvenience that the characteristics of the retractable antenna A is unstable.

Further, in the above conventional mobile phone T, the antenna holder H and fixing nut N are formed of a heavy metal material. Thus, in particular, such a heavy metal material is problematic in a mobile terminal device in which there is a growing demand for weight reduction as in the mobile phone T.

### BRIEF SUMMARY OF THE INVENTION

It is an object of the present invention to provide a mobile terminal device capable of achieving the predetermined performance such as good transmission characteristic without requiring complicated adjustment work, capable of achieving stable antenna characteristics, and capable of weight reduction.

According to an aspect of the invention, there is provided a mobile terminal device provided with a circuit board including a signal-feeding circuit for feeding a radio frequency signal, comprising:

a housing configured to receive the circuit board;

an antenna;

an antenna holder configured to hold the antenna, which is formed of a non-metal material;

a holder fitting configured to support the antenna holder, which is formed of a non-metal material and is fixed on the housing, the antenna holder being attached to the holder fitting; and

a signal-feeding member configured to feed the radio frequency signal to the antenna from the circuit board, the signal-feeding member being supported by the holder fitting.

According to an another aspect of the invention, there is provided a mobile terminal device provide with a circuit board including a signal-feeding circuit for feeding a radio frequency signal, comprising:

a housing configured to receive the circuit board;

an antenna;

an antenna holder configured to hold the antenna, which includes an outer section formed of a non-metal material and inner section coaxially arranged in the outer section and formed of an electrical conductive metal member;

a holder fitting configured to support the antenna holder, which is formed of a non-metal material and is fixed on the housing, the antenna holder being attached to the holder fitting; and

a signal-feeding member configured to feed the signal to the antenna from the circuit board, the signal-feeding member being supported by the holder fitting and contacted to the circuit board.

According to a yet another aspect of the invention, there is provided a mobile terminal device provide with a circuit board including a signal-feeding circuit for feeding a radio frequency signal, comprising:

a housing configured to receive the circuit board;

an antenna;

an antenna holder configured to hold the antenna, which includes an outer section formed of a non-metal material and an inner section coaxially arranged in the outer section and formed of an electrical conductive metal member;

a holder fitting configured to support the antenna holder, which is formed of a non-metal material and is fixed on the housing, the antenna holder being attached to the holder fitting; and

a signal-feeding member configured to feed the signal to the antenna from the circuit board, the signal-feeding member being supported by the holder fitting and contacted to the circuit board..

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a perspective view schematically showing an appearance of a conventional mobile terminal device;

FIG. 2A and FIG. 2B are sectional views each schematically showing an antenna structure of the mobile terminal device shown in FIG. 1;

FIG. 3 is a perspective view schematically showing an appearance of a mobile phone serving as a mobile terminal device according to one embodiment of the present invention;

FIG. 4A and FIG. 4B are a sectional view and side view schematically showing an antenna structure of the mobile terminal device shown in FIG. 3;

FIG. 4C is an oblique view schematically showing the coupling spring structure shown in FIG. 4A and FIG. 4B;

FIG. 5A and FIG. 5B are a schematic sectional view and a side view showing a part of the antenna structure of the mobile terminal device shown in FIG. 4A and FIG. 4B in an enlarged manner;

FIG. 6 is a cross sectional view along a VI-VI line shown in FIG. 4A, showing the antenna structure of the mobile terminal device in which the antenna is retracted in the casing of the mobile terminal device;

FIG. 7 is a cross sectional view along a VII-VII line shown in FIG. 5A, showing the antenna structure of the mobile terminal device in which the antenna is extended from the casing of the mobile terminal device;

FIG. 8A and FIG. 8B are an exploded sectional view and a side view each schematically showing an antenna structure of a mobile terminal device according to a second embodiment of the present invention in an enlarged manner;

FIG. 8C is an oblique view schematically showing the coupling spring structure shown in FIG. 4A and FIG. 4B;

FIG. 9A and FIG. 9B are an exploded sectional view and a side view schematically showing a part of the antenna structure of the mobile terminal device shown in FIG. 8A and FIG. 8B in an enlarged manner;

FIG. 10 is a cross sectional view along a X-X line shown in FIG. 8A, showing the antenna structure of the mobile terminal device in which the antenna is retracted in the casing of the mobile terminal device;

FIG. 11 is a cross sectional view along a XI-XI line shown in FIG. 9A, showing the antenna structure of the mobile terminal device in which the antenna is extended from the casing of the mobile terminal device;

FIG. 12A and FIG. 12B are an exploded sectional view and a side view each schematically showing an antenna structure of a mobile terminal device according to a third embodiment of the present invention in enlarged manner;

FIG. 13A and FIG. 13B are an exploded sectional view and a side view schematically showing a part of the antenna structure shown in FIG. 12A and FIG. 12B in an enlarged manner;

FIG. 14 is a cross sectional view along a XIV-XIV line shown in FIG. 12A, showing the antenna structure of the mobile terminal device in which the antenna is retracted in the casing of the mobile terminal device;

FIG. 15 is a cross sectional view along a XV-XV line shown in FIG. 13A, showing the antenna structure of the mobile terminal device in which the antenna is extended from the casing of the mobile terminal device;

FIG. 16 is a schematic cross section showing an internal structure of a signal-feeding pin of the mobile terminal device shown in FIG. 12A and FIG. 12B;

FIG. 17A and FIG. 17B are an exploded sectional view and a side view each schematically showing an antenna structure of a mobile terminal device according to a fourth embodiment of the present invention in an enlarged manner;

FIG. 18A and FIG. 18B are an exploded sectional view and a side view each schematically showing a part of the antenna structure shown in FIG. 17A and FIG. 17B in an enlarged manner;

FIG. 19 is a schematic cross section showing an internal structure of a signal-feeding pin of the mobile terminal device shown in FIG. 17A and FIG. 17B;

FIG. 20A and FIG. 20B are an exploded sectional view and a side view each schematically showing a part of an antenna structure according to a fifth embodiment of the present invention in an enlarged manner;

FIG. 21A and FIG. 21B are an exploded sectional view and a side view each schematically showing a part of the antenna structure shown in FIG. 20A and FIG. 20B in an enlarged manner; and

FIG. 22 and FIG. 23 are sectional views schematically showing a part of an antenna structure according to a sixth embodiment of the present invention.

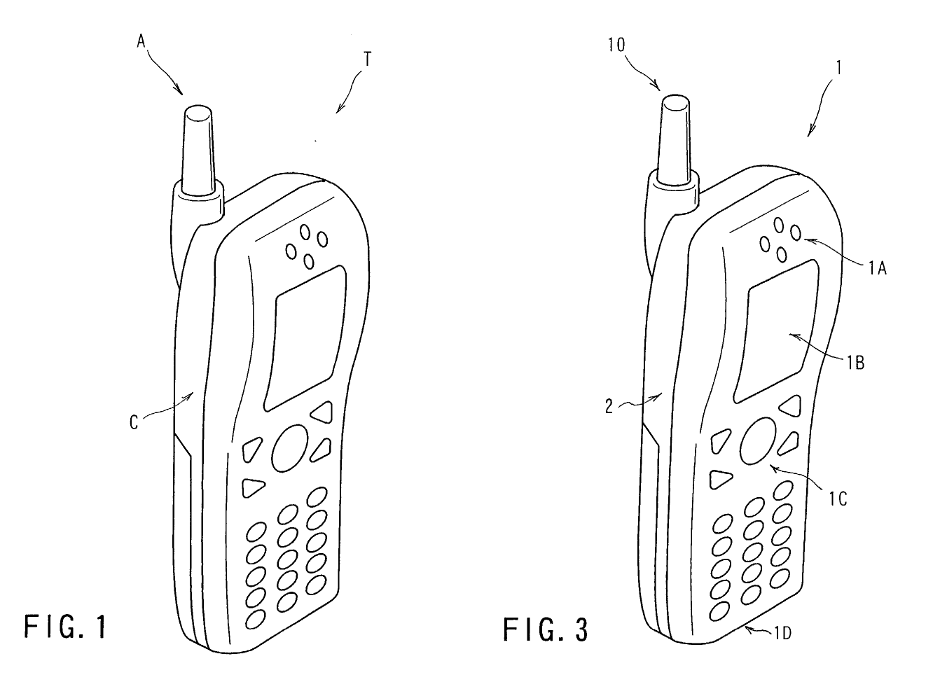

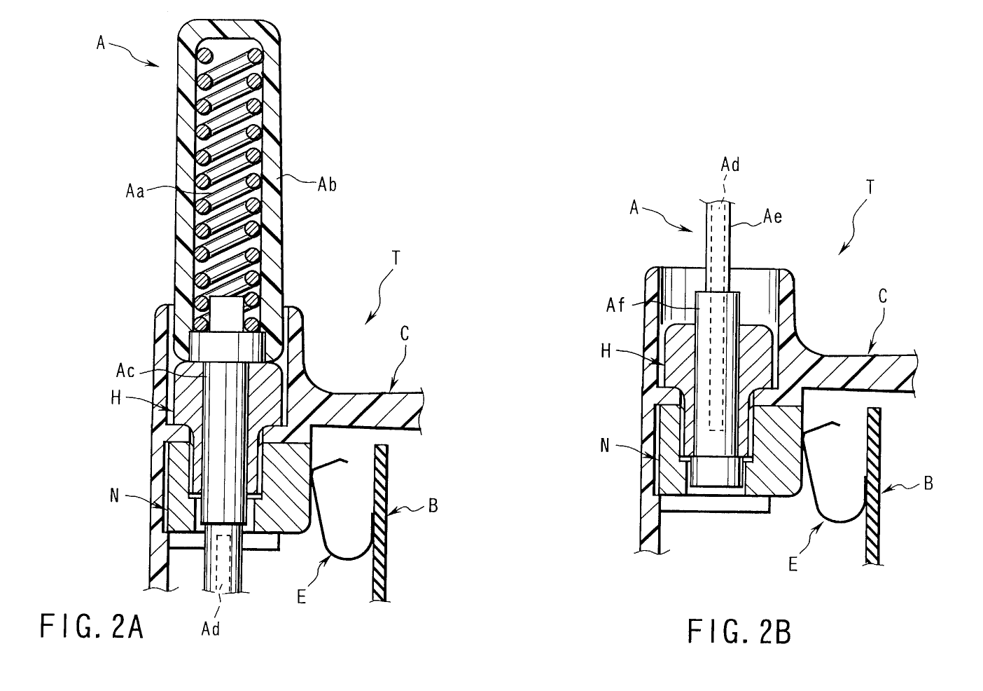

### DETAILED DESCRIPTION OF THE INVENTION

Hereinafter, a mobile terminal device according to preferred embodiments of the present invention will be described with reference to the accompanying drawings.

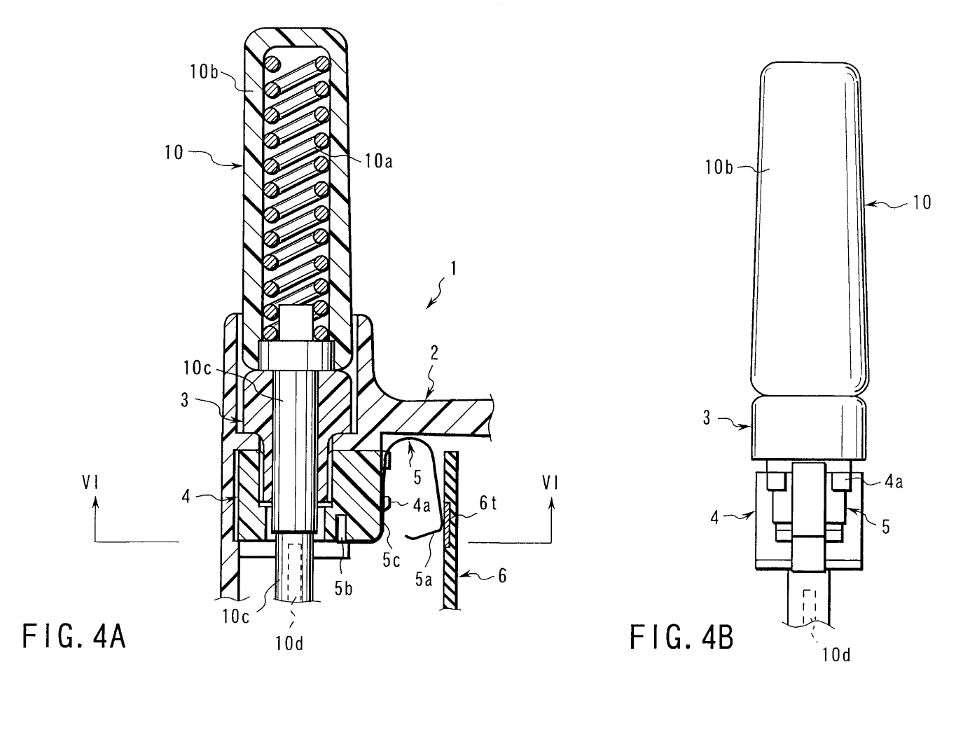

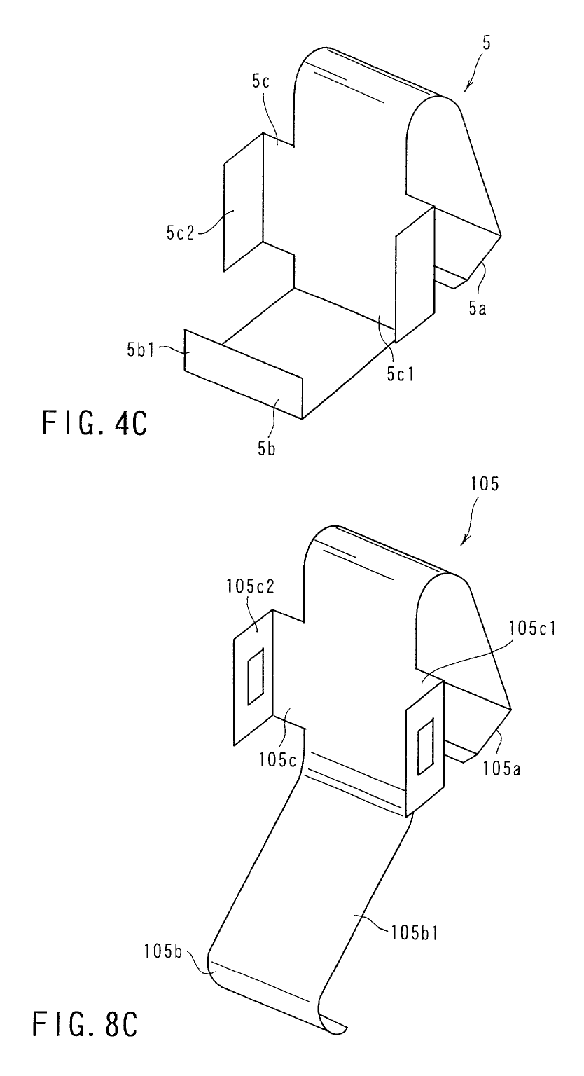

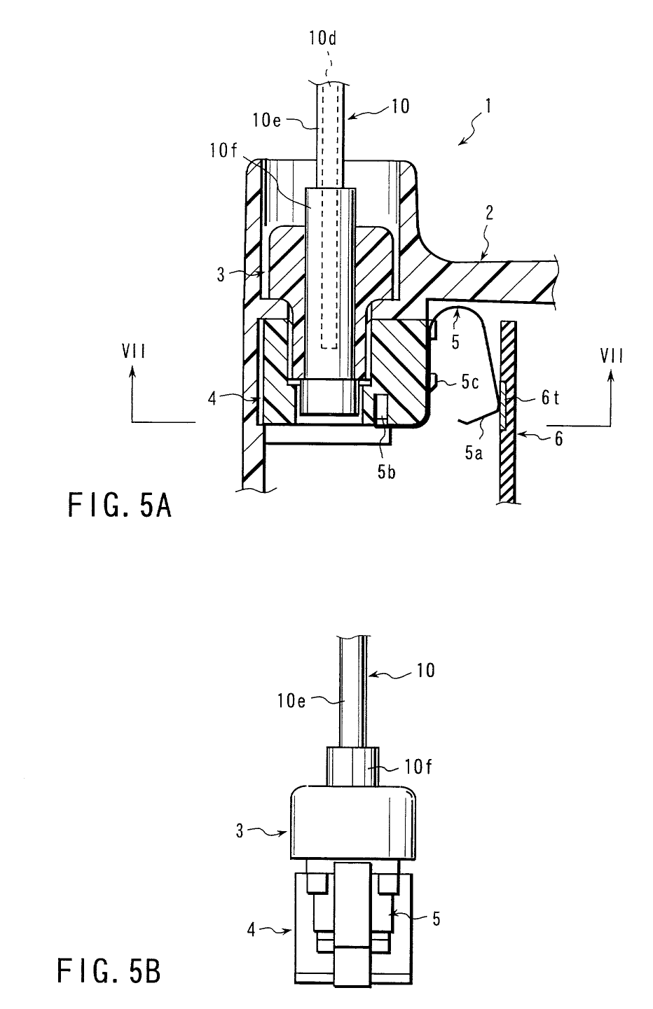

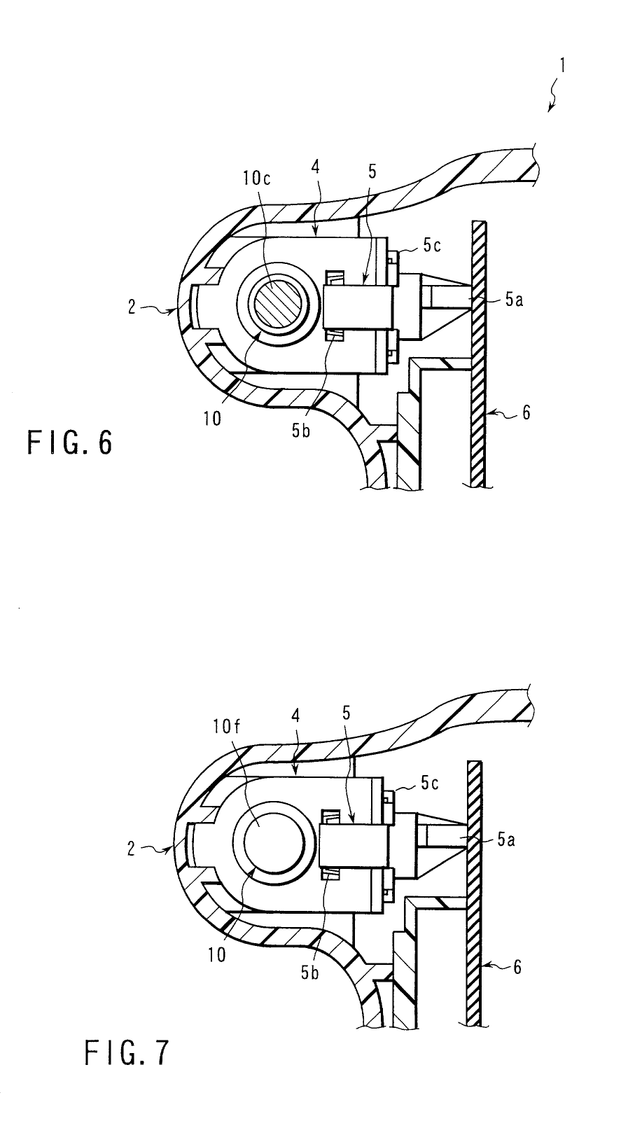

FIG. 3 to FIG. 7 each show a first embodiment when the present invention is applied to a mobile phone serving as a mobile terminal device. FIG. 3 is a perspective view showing an appearance of a mobile phone. FIG. 4A is an enlarged view showing an antenna structure of supporting a retractable antenna on a casing or a housing in a breakaway manner, the figure showing a state in which the retractable antenna 10 is housed in a casing 2. FIG. 4B is a side view when a coupling spring member 5 shown in FIG. 4A is oriented to a front face while the casing 2 is removed, the figure showing an external structure of the retractable antenna 10. FIG. 5A is an enlarged view schematically showing a proximal section of the antenna structure in a partial breakaway manner, the figure showing a state in which the retractable antenna 10 is extended from the casing 2. FIG. 5B is a side view when the coupling spring member 5 shown in FIG. 5A is oriented to a front face while the casing 2 is removed. FIG. 6 is a sectional view taken along the line VI-VI shown in FIG. 4A in which the retractable antenna structure in the casing 2 is viewed downwardly while the retractable antenna 10 is housed in the casing 2. FIG. 7 is a sectional view taken along the line VII-VII shown in FIG. 4A in which the retractable antenna structure in the casing 2 is viewed downwardly while the retractable antenna 10 is extended from the casing 2.

As shown in FIG. 3, at the mobile phone 1, on its front face, there are provided: the casing 2 having a receiver section or a microphone section 1A, a liquid crystal display section 1B, a key operating section 1C, and a transmitter or a speaker section 1D; and the retractable antenna (antenna) 10 provided so as to be housed at an end of this casing 2.

As shown in FIG. 4A to FIG. 5B, the retractable antenna 10 is provided with an antenna cap 10b housing a helical cap 10b at a top part thereof. At the helical section 10a in this antenna cap 10b, a sleeve 10c serving as a first contact point is fixed to this antenna cap 10b, and the sleeve 10c is extended along an axis of the antenna cap 10b and helical section 10a. In addition, one end of a tube 10e extended in the casing 2 is fixed to this sleeve 10c, and an antenna element 10d is housed in this tube 10e. As shown in FIG. 5A, a stopper 10f serving as a second contact point to which the antenna element 10d is electrically connected is fixed to the other end of the tube 10e. As described later, an insert hole is provided at an antenna holder 3 securely provided in the casing 2. While the antenna is housed, the sleeve 10c is held in this insert hole. While the antenna is extended, the stopper 10f is held in this insert hole. When the antenna is extended, the tube 10e is slid in the insert hole inside of the tube. With such an antenna structure, the antenna is supported in the casing 2.

The antenna holder 3 is a cylindrical member into which the retractable antenna 10 is inserted, and is made of a POM resin that is a non-metal material. This antenna holder 3 is screwed to a fixing nut, i.e., a holder fitting 4 fixed in the casing 2, whereby the retractable antenna 10 is supported by the casing 2.

In a mobile phone according to one embodiment of the present invention, although the antenna holder 3 and fixing nut 4 are formed of a resin that is a nonmetal material, the antenna holder 3 and fixing nut 4 can be formed by employing a variety of non-metal materials such as a PBT resin, a PC resin, a PPE resin, or an ABS, for example, other than the POM resin as long as such a material has good electrical insulation properties.

Further, in the mobile phone of the above embodiment, although a fixing nut screwed to the antenna holder 3 is employed as a holder fitting, the tightening between the antenna holder and holder fitting is not limited to such a screwing. For example, there may be provided a structure in which the antenna holder and holder fitting are tightened after being engaged with each other at a claw section provided at one or both thereof.

As shown in FIG. 4 to FIG. 7, a coupling spring member having a signal-feeding section 5b, i.e., a signal feeding part 5 is mounted on the fixing nut 4. The signal-feeding section 5b of this coupling spring member 5 is capacity-coupled with the retractable antenna 10, and transmission signal is fed from the signal-feeding section 5b to the retractable antenna 10 via the capacity between both of them.

The coupling spring member 5 has a support section 5c and a contact section 5a in addition to the signal-feeding section 5b, and is formed of an electrically conductive member such as a metal in an integrally structural manner, as shown in FIG. 4A and FIG. 4C. The support section 5c has a fixing section to be fixed in intimate contact with the fixing nut 4. This fixing section is securely fixed to the fixing nut 4, whereby the coupling spring member 5 is placed on this fixing nut 4. That is, the fixing section has a flat section 5c1 and bending sections 5c2 that are so extended from both side of the flat section 5c1 as to bend on the side faces of the fixing nut 4. The flat section 5c1 is mounted on the flat side face of the fixing nut 4 and is engaged with projections 4a provided on the flat side face of the fixing nut 4, and the bending section 5c2 are mounted on the side faces of the fixing nut 4. Thus, the coupling spring member 5 is fixed on the fixing nut 4 at a predetermined position. The signal-feeding section 5b is extended from this support section 5c along the bottom face of the fixing nut 4 and a tongue 5b1, i.e., a tip end of the signal-feeding section 5b is fixed in the fixing nut 4. The fixing nut 4 has a recess formed therein and a block piece is received in the recess, and the tongue 5b1 is inserted in a small gap formed between the recess face and the block piece so that the signal-feeding section 5b is fixed on the fixing nut 4. Thus, the tongue 5b1 of the signal-feeding section 5b fixed in the fixing nut 4 is opposed to the sleeve 10c or stopper 10f of the retractable antenna 10 with a predetermined gap. In addition, the support section 5c has an extension section for applying a resilient force to be extended from the fixing section toward a circuit board 6 described later in an archery shape. At a free end of this extension section, there is provided the contact section 5a which is brought into contact with a signal-feeding terminal 6t of the circuit board 6 by the resilient force of the coupling spring member 5. The signal-feeding terminal 6t and contact section 5a are electrically connected to each other by being brought into contact with each other.

The fixing nut 4 is tightened with the antenna holder 3 for supporting the retractable antenna 10. Thus, the coupling spring member 5 supported by the fixing nut 4 is precisely positioned at a predetermined location relevant to the retractable antenna 10, i.e., in such a manner that the signal-feeding section 5b is spaced from the sleeve 10c or stopper 10f of the retractable antenna 10 by dimensions suitable to capacity coupling.

On the other hand, the circuit board 6 is housed and placed inside of the casing 2, and the contact section 5a of the coupling spring member 5 is brought into contact with the signal-feeding terminal 6t formed on this circuit board 6.

A contact with the signal-feeding terminal 6t of the circuit board 6 is brought by the contact section 5a of the coupling spring member 5. For example, even in the case where an assembling position of the circuit board 6 relevant to the casing 2 is slightly displaced, the signal-feeding terminal 6t of the circuit board 6 is reliably connected to the coupling spring member 5. Thus, there does not occur inconvenience in signal feeding from the circuit board 6 to the retractable antenna 10.

In the above mobile phone 1 according to the above embodiment, while the retractable antenna 10 shown in FIG. 4A and FIG. 6 is housed in the casing 2, the sleeve 10c is engaged with the antenna holder 3. In this manner, the sleeve 10c and the signal-feeding section 5b of the coupling spring member 5 are capacity-coupled with each other, whereby the signal is fed from the circuit board 6 to the helical section 10a via the coupling spring member 5 and the sleeve 10c of the retractable antenna 1. The signal feeding used here denotes feeding of a high frequency radio signal which is generated from a high frequency circuit provided on the circuit board 6. Even during capacity coupling, a radio frequency signal can be fed through the capacity coupling.

On the other hand, while the retractable antenna 10 shown in FIG. 5A and FIG. 7 is extended from the casing 2, the stopper 10f is engaged with the antenna holder 3. In this manner, the stopper 10f and the signal-feeding section 5b of the coupling spring member 5 are capacity-coupled with each other, whereby the signal is fed from the circuit board 6 to the antenna element 10d via the coupling spring member 5 and the stopper 10f.

In the mobile phone 1 of the above embodiment, the antenna holder 3 and fixing nut 4 are formed of a non-metal material such as a resin. In addition, the transmission signal is fed to the retractable antenna 10 via the coupling spring member 5 supported by the fixing nut 4. Thus, a member with its large capacity consisting of a metal material is not interposed in a signal-feeding path. Therefore, a change in impedance matching caused by interposition of a metal material is restricted, and a signal transmission loss in the retractable antenna 10 is eliminated. As a result, the predetermined performance such as transmission characteristic in the retractable antenna 10 can be achieved without requiring complicated adjustment work.

In addition, in the mobile phone 1 according to the above embodiment, the transmission signal is fed to the retractable antenna 10 via the coupling spring member 5 supported by the fixing nut 4. Thus, a contact site between members in the signal-feeding path significantly decreases. Therefore, a deterioration of antenna properties based on a change in contact state between the members is restricted, whereby the characteristics of the retractable antenna 10 is stabilized.

Further, in the mobile phone 1 according to the above embodiment, the antenna holder 3 and the fixing nut 4 are formed of a non-metal material such as a resin. Thus, this resin is much lighter than a metal material in weight, thus making it possible to significantly reduce the entire weight.

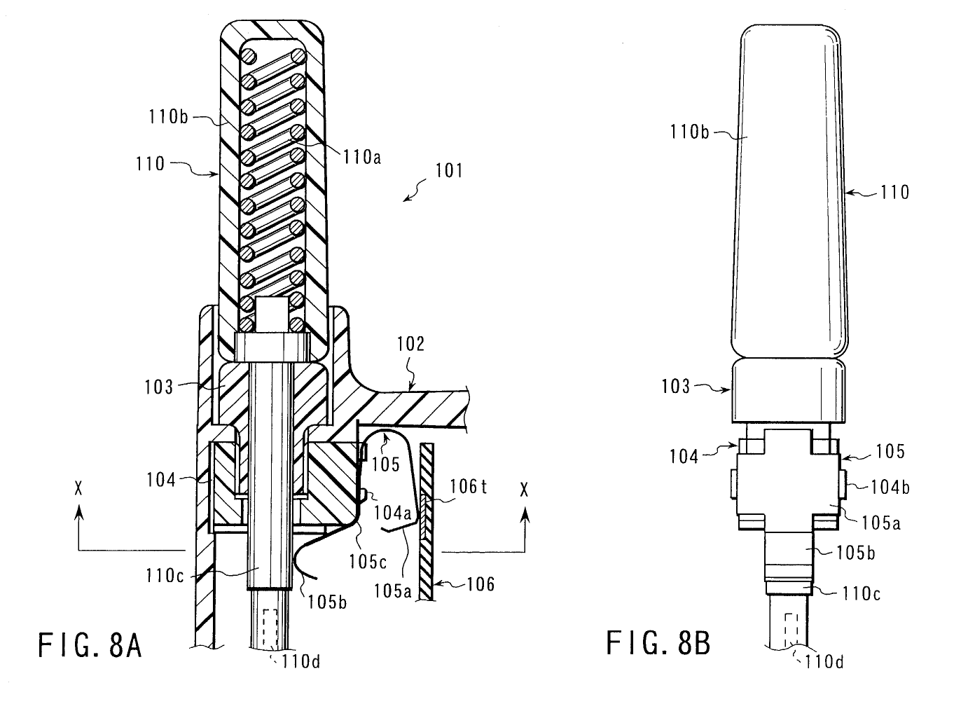

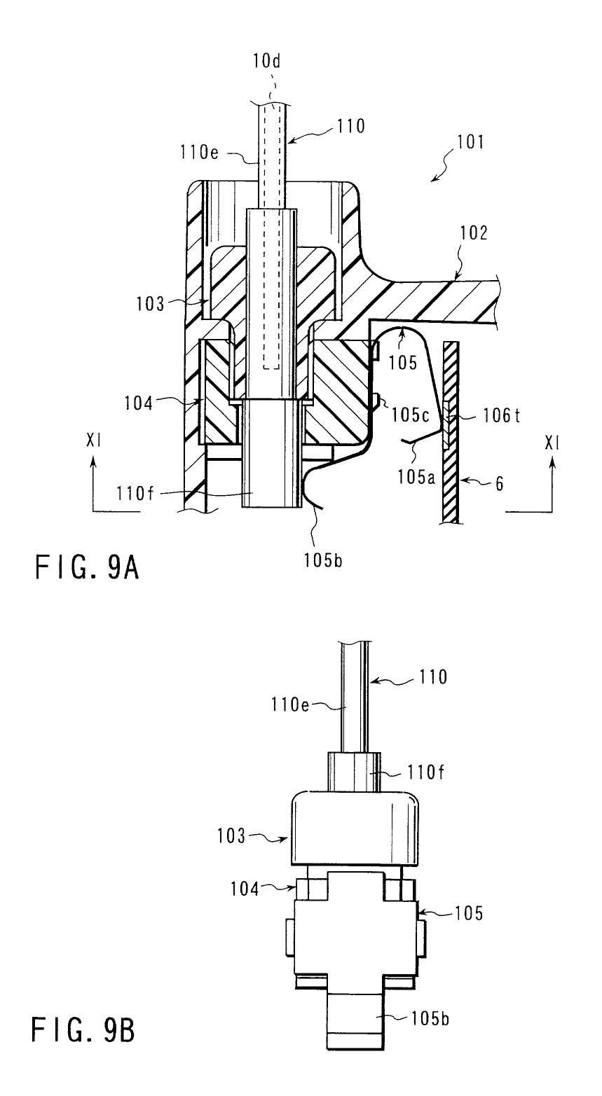

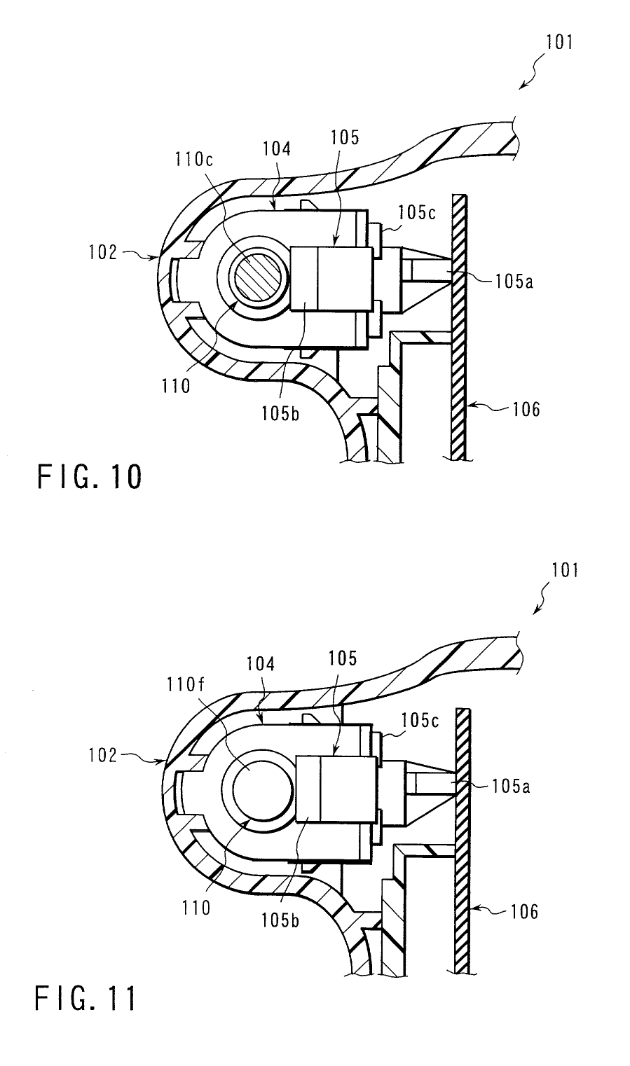

FIG. 8A to FIG. 11 each show a second embodiment when the present invention is applied to a mobile phone. FIG. 8A is an enlarged view showing an antenna structure provided at this mobile phone in a breakaway manner, the figure showing a state in which a retractable antenna 110 is housed in a casing 102. FIG. 8B is a side view of the antenna structure shown in FIG. 8A when a coupling spring member 105 shown in FIG. 8A is oriented to a frontal face. FIG. 9A is an enlarged view showing an antenna structure in a breakaway manner, the figure showing a state in which the retractable antenna 110 is extended from the casing 102. FIG. 9B is a side view of an antenna structure when the coupling spring member 105 shown in FIG. 9A is oriented to a front face. FIG. 10 is a sectional view taken along the line X-X shown in FIG. 8A when the retractable antenna structure in the casing 102 is viewed downwardly while the retractable antenna 110 is housed in the casing 2. FIG. 11 is a sectional view taken along the line XI-XI shown in FIG. 9A when the retractable antenna structure in the casing 102 is viewed downwardly while the retractable antenna 110 is led out in the casing 2.

With respect to a description of a mobile phone according to the second embodiment, a description of elements and structure identical to those of the mobile phone according to the first embodiment is omitted here. Only a different structure thereof will be described in more detail.

In a mobile phone according to the second embodiment, the coupling spring member , i.e., signal-feeding member 105, shown in FIG. 8C, for feeding a signal to the retractable antenna 110 through direct contact is mounted on a fixing nut 104. This coupling spring member 105 has a support portion 105c installed to be fixed to the fixing nut 104 a signal-feeding section 105b coming into direct contact with the retractable antenna 110 and a contact section 105a coming into contact with a signal-feeding terminal 106t of a circuit board 106.

The coupling spring member 105 supported by the fixing nut 104 is precisely positioned so as to come into direct contact with a sleeve 110c and a stopper 110f of the retractable antenna 110. That is, the coupling spring member 105 has a flat section 105c1 and bending sections 105c2 that are so extended from both side of the flat section 105c1 as to bend on the side faces of the fixing nut 104. The flat section 5c1 is mounted on the flat side face of the fixing nut 104 and is engaged with projections 104a provided on the flat side face of the fixing nut 104, and the bending section 105c2 are mounted on the side faces of the fixing nut 104. Thus, the coupling spring member 105 is fixed on the fixing nut 4 at a predetermined position. A extending section 105b is extended from the flat section 105c1 to the sleeve 110c or the stopper 110f of the antenna 110, and the free end 105b of the extending section 105b is electrically and mechanically contacted to the sleeve 110c or the stopper 110f of the antenna 110.

In the above mobile phone 101, while the retractable antenna 110 shown in FIG. 8A and FIG. 10 is housed in the casing 102, the sleeve 110c of the retractable antenna 110 is engaged with the antenna holder 103. In this manner, the sleeve 110c and the signal-feeding section 105b of the coupling spring member 105 come into direct contact with each other, whereby the signal is fed from the circuit board 106 to the helical section 110a via the coupling spring member 105 the sleeve 110c of the retractable antenna 110.

On the other hand, while the antenna 110 shown in FIG. 9A and FIG. 11 is extended from the casing 2, the stopper 10f of the antenna 110 is engaged with the antenna holder 103. In this manner, the stopper 110f and the signal-feeding section 105b of the coupling spring member 105 come into contact with each other, whereby the signal is fed from the circuit board 106 to the antenna element 110d via the coupling spring member 105, and the stopper 10f.

In the mobile phone 101 according to the above embodiment as well, the antenna holder 103 and the fixing nut 104 are formed of a non-metal material made of a resin, and the coupling spring member 105 for feeding a signal to the retractable antenna 110 is supported by the fixing nut 104. In this manner, as in the mobile phone 1 according to the first embodiment, the predetermined performance such as transmission characteristic in the retractable antenna 110 can be achieved without requiring a complicated adjustment work. In addition, the stable characteristics of the retractable antenna 110 can be achieved. Further, the entire weight can be significantly reduced.

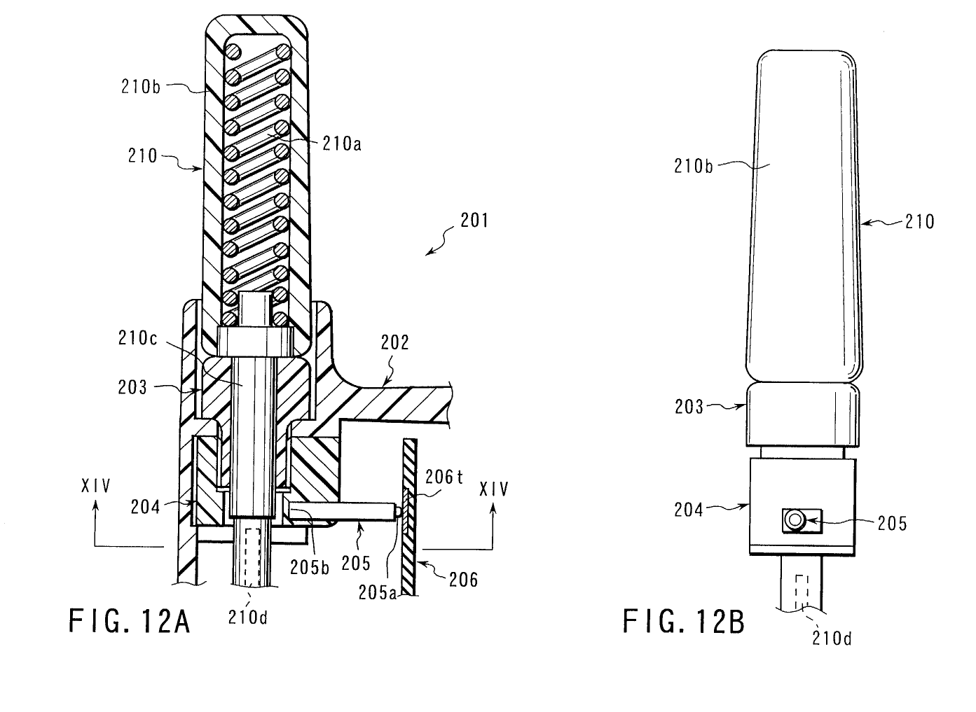

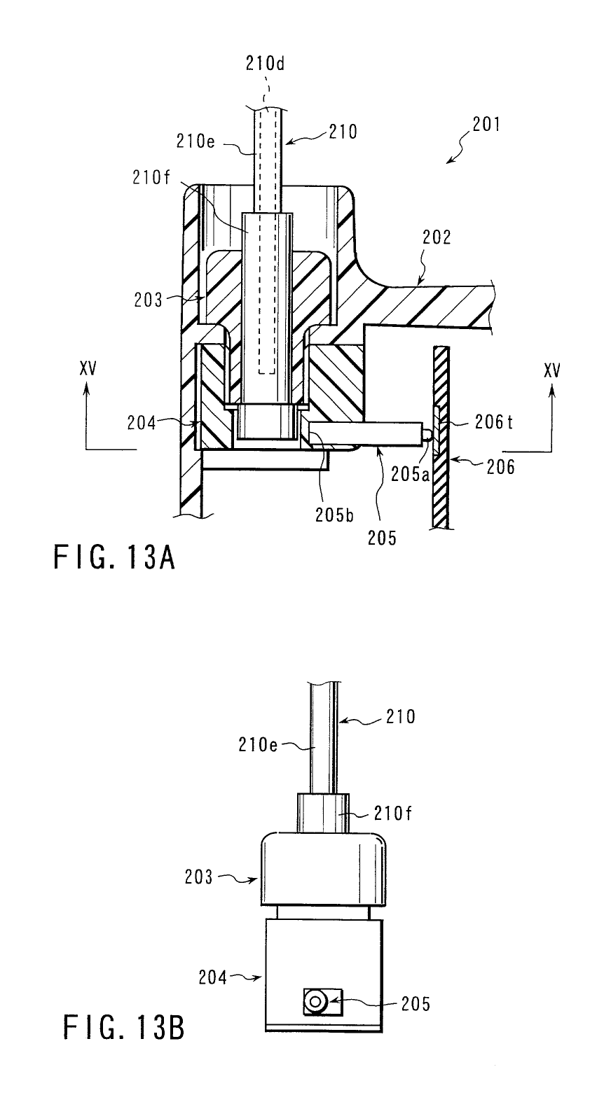

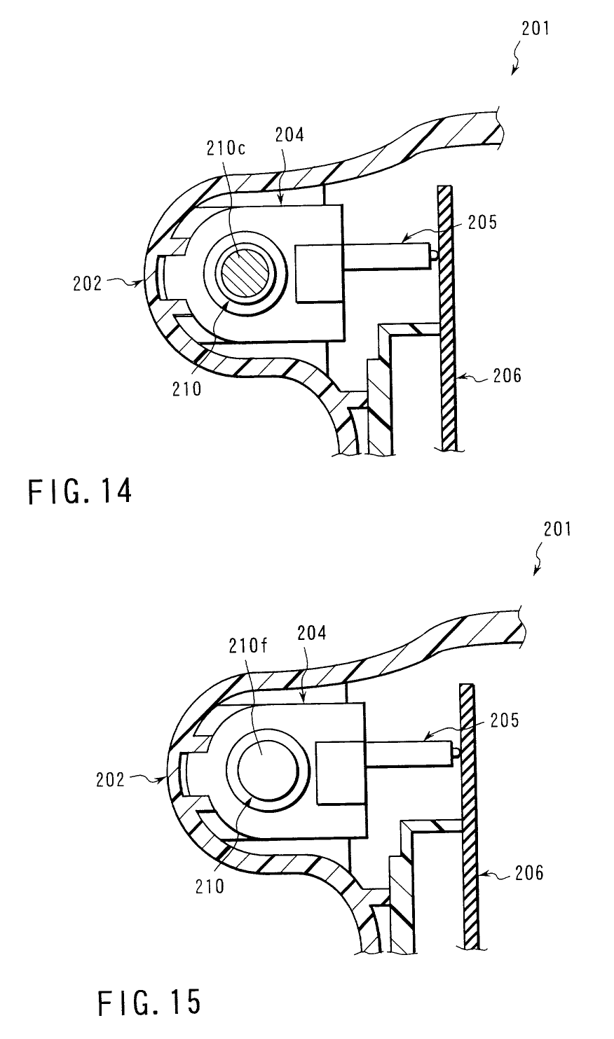

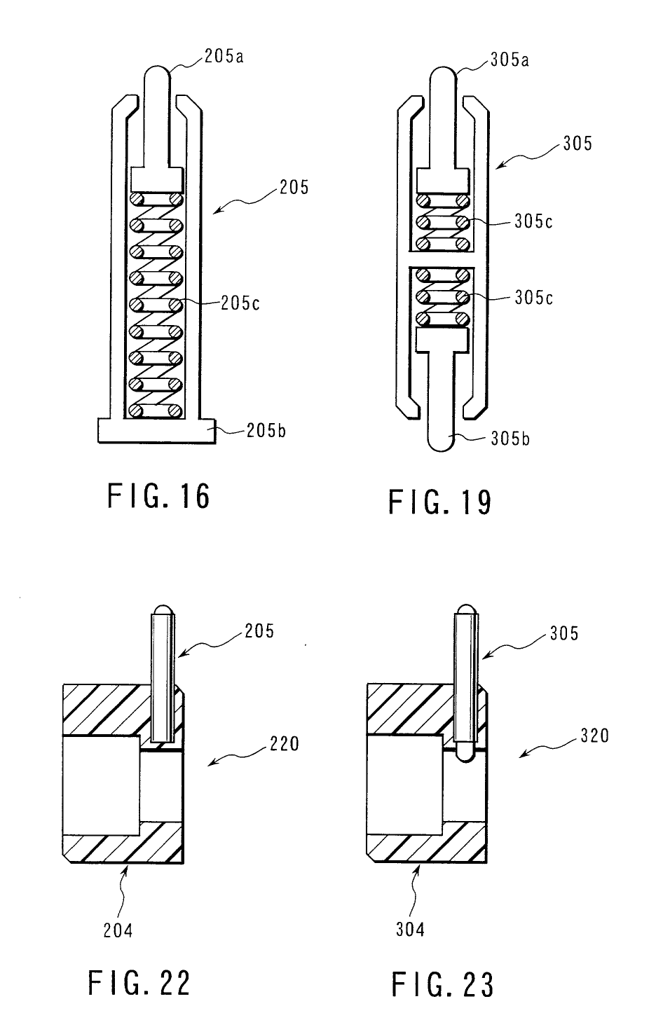

FIG. 12A to FIG. 16 each show a third embodiment when the present embodiment is applied to a mobile phone. FIG. 12A is an enlarged view showing an antenna structure of a mobile phone according to the third embodiment in a partially breakaway manner, the figure showing a state in which a retractable antenna 210 is housed in a casing 202. FIG. 12B is a side view of an antenna structure when a signal-feeding pin 205 shown in FIG. 12A is oriented to a front face while the casing 202 is removed, the figure showing an external structure of the retractable antenna 10. FIG. 13A is an enlarged view showing a proximal section of the antenna structure in a partially breakaway manner, the figure showing a state in which the retractable antenna 210 is extended from the casing 202. FIG. 13B is a side view when the signal-feeding pin 205 shown in FIG. 12A and FIG. 12B is oriented to a front face. FIG. 14 is a sectional view taken along the line XIV-XIV shown in FIG. 12A, the figure showing a state in which the retractable antenna 210 is housed in the casing 202. FIG. 15 is a sectional view taken along the line XV-XV shown in FIG. 13A, the figure showing a state in which the retractable antenna 210 is extended from the casing 202. FIG. 16 is a sectional view schematically showing an internal structure of the signal-feeding pin 205 shown in FIG. 12A and FIG. 12B.

With respect to a description of a mobile phone according to the third embodiment, a description of the elements and structure identical to those of the mobile phone of the first embodiment are eliminated, and a different structure thereof will be described in more detail.

In the mobile phone according to the third embodiment, a rod shaped signal-feeding pin in which the proximal section is fixed to be embedded in a fixing nut 204, i.e., the signal-feeding member 205 is mounted on the fixing nut 204. This signal-feeding pin 205 is formed in a substantially hollow cylinder shape, as shown in FIG. 16. A proximal end at one end thereof has a signal-feeding section 205b formed in a flange shape in order to prevent the proximal section from slipping out from the fixing nut 204. This signal-feeding section 205b is embedded in the fixing nut 204, and is opposed to the retractable antenna 210 with a predetermined interval. This signal-feeding section 205b is electrically connected to the retractable antenna 210 by capacity coupling, and the signal is fed to the antenna 210 via this signal-feeding section 205b. From this flange shaped signal-feeding section 205b, a cylindrical section opened at one end thereof is extended. A spring 205c is provided in the cylindrical section of this signal-feeding member 205, and a contact pin in which a bias is applied by this spring 205c is provided in the cylinder top part of this signal-feeding terminal 205. This contact pin has a contact section 205a rounded at its top part in order to come into contact with a signal-feeding terminal 206t of a circuit board 206, and has a flange shaped proximal section to prevent the contact section from slip off from the inside of the cylindrical section.

The fixing nut 204 is tightened to an antenna holder 203 for supporting the retractable antenna 210. Therefore, the signal-feeding pin 205 supported by the fixing nut 204 is precisely positioned at a predetermined position relevant to the retractable antenna 210, i.e., in such a manner that the signal feeding 205b is spaced from a sleeve 210c and a stopper 210f of the retractable antenna 210 by dimensions suitable to capacity coupling.

On the other hand, as shown in FIG. 12A, the circuit board 206 is installed to be housed inside of the casing 202. A contact section 205a of the signal-feeding pin 205 supported by the fixing nut 204 is brought into contact with a signal-feeding terminal 206t formed on this circuit board 206, as described above.

Here, the contact section 205a of the signal-feeding pin 205 is compressed to the circuit board 206 side with resilient force of the spring 205c. Therefore, even if the circuit board 206 is fixed at a slightly displaced assembling position relevant to the casing 202, the signal-feeding terminal 206t of the circuit board 206 is reliably connected to the signal-feeding pin 205. As a result, in the signal-feeding member 205, the signal can be reliably fed from the circuit board 6 to the retractable antenna 210.

In the mobile phone 201 having the above structure, as shown in FIG. 12A and FIG. 14, while the retractable antenna 210 is housed in the casing 202, the sleeve 210c is engaged with the antenna holder 203. Therefore, this sleeve 210c is capacity-coupled with the signal-feeding section 205b of the signal-feeding pin 205, and the signal is reliably fed from the circuit board 206 to the helical section 210a via the signal-feeding pin 205 and the sleeve 210c of the retractable antenna 210.

On the other hand, as shown in FIG. 13A and FIG. 15, while the retractable antenna 210 is extended from the casing 202, the stopper 210f is engaged with the antenna holder 203. Therefore, this stopper 210f is capacity-coupled with the signal-feeding section 205b of the signal-feeding pin 205, and the signal is reliably fed from the circuit board 206 to the antenna element 210d via the signal-feeding pin 205, and the stopper 210f.

In the mobile phone 201 according to the above third embodiment, the antenna holder 203 and fixing nut 204 are formed of a non-metal material such as a resin, and the signal is fed to the signal is fed to the retractable antenna 210 via the signal-feeding pin 205 supported by the fixing nut 204. Therefore, a member with its large capacity consisting of a metal material is not interposed in the signal-feeding path. As a result, a change in impedance caused by interposition of a metal material is restricted, and the transmission loss in the retractable antenna 210 is reduce to the minimum. Because the antenna structure is simple, the predetermined performance such as transmission characteristic in the retractable antenna 210 can be achieved without requiring complicated adjustment work.

In addition, the signal is fed to the retractable antenna 210 via the signal-feeding pin 205 supported by the fixing nut 204, and thus, a contact site between the members in the signal feeding path significantly decreases. Thus, a deviation in antenna characteristics based on a change in contact state between the members is restricted, whereby the characteristics of the retractable antenna 210 can be stabilized.

In addition, the signal-feeding member utilizes the signal-feeding pin 205. Thus, the signal can be fed with the shortest distance from the antenna sleeve 210c or stopper 210f to the signal-feeding terminal 206t on the circuit board 206. Therefore, a signal-feeding distance is the shortest, an inductor component is reduced, and degradation of efficiency therein hardly occurs. Moreover, with an effect caused by the antenna holder 203 and fixing nut 204 being formed of a non-metal material such as a resin, the predetermined performance such as transmission characteristic in the retractable antenna 210 can be achieved. In addition, a disturbance in directivity of the retractable antenna 210 hardly occurs.

Further, the antenna holder 203 and fixing nut 204 are formed of a non-metal material such as a resin, thus making it possible to significantly reduce the entire weight.

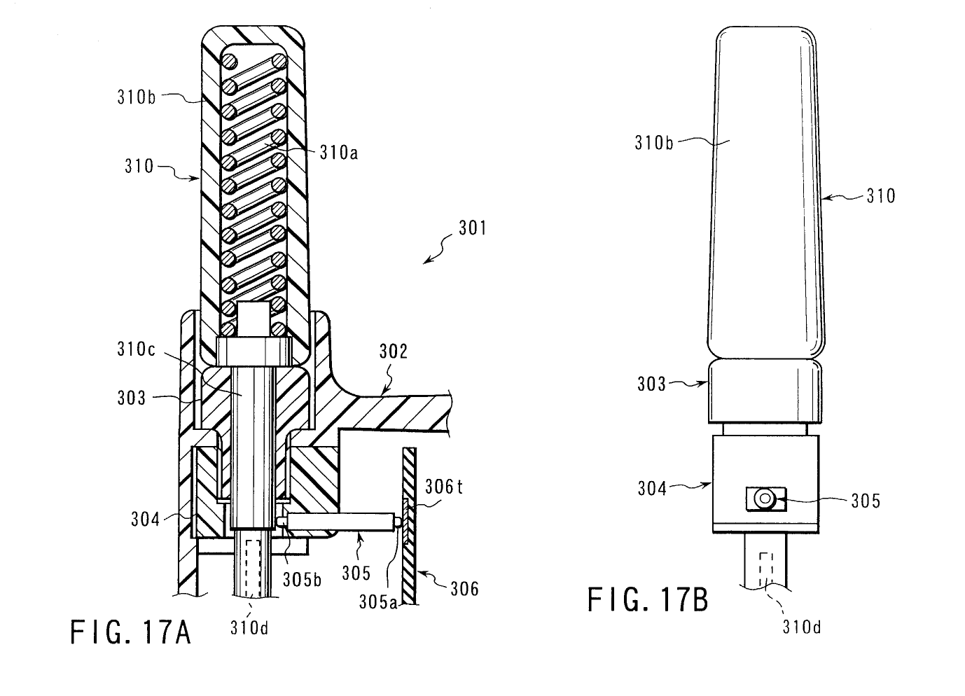

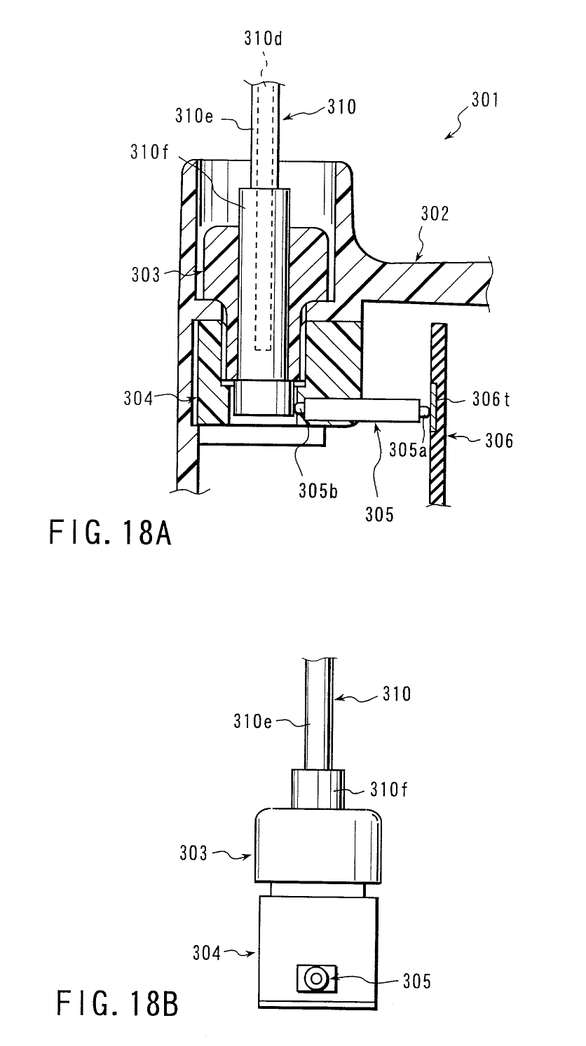

FIG. 17A to FIG. 19 each show a fourth embodiment when the present invention is applied to a mobile phone. FIG. 17A is an external view schematically showing an antenna structure according to the fourth embodiment in a partly breakaway manner, the figure showing a state in which a retractable antenna 310 is retracted in a casing 302. FIG. 17B is a side view of an antenna structure when a signal-feeding pin 305 shown in FIG. 17A is oriented to a front face. FIG. 18A is an enlarged view showing an antenna structure in a breakaway manner, the figure showing a state in which the retractable antenna 310 is extended from the casing 302. FIG. 18B is a side view showing a part of the antenna structure when the signal-feeding pin 305 shown in FIG. 18A is oriented to a front face in an enlarged manner. FIG. 19 is a view showing an internal structure of the signal-feeding pin 305 shown in FIG. 18A.

With respect to a description of a mobile phone according to the fourth embodiment, a description of the elements and structure identical to those of the mobile phone of the first embodiment are eliminated, and a different structure thereof will be described in more detail.

In the antenna structure according to the fourth embodiment, a linearly shaped signal-feeding pin 305 is pressed into the fixing nut 304, and a bellows section thereof is fixed to be embedded in a fixing nut 304. This signal-feeding pin 305 has a contact section 305b protruded in a gap between the retractable antenna 310 and the fixing nut 304, the contact section 305b at one end coming into direct contact with a sleeve 310c or a stopper 310f of the retractable antenna 310. In addition, the signal-feeding pin 305 has a contact section 305a protruded toward a signal-feeding terminal 306t on a circuit board 306, the contact section 305a at the other end being brought into contact with the signal-feeding terminal 306t. The contact sections 305a and 305b are slidably provided along its axis so as to come into contact with the sleeve 310c or stopper 310f of the retractable antenna 310 respectively and the signal-feeding terminal 306t on the circuit board 306.

This signal-feeding pin 305 has a hollow shaped cylindrical section partitioned by a bulkhead therein and opened at both ends as shown in FIG. 19. A spring 305c is provided on the bulkhead in the cylindrical section. A pin having the contact sections 305a and 305b rounded at its tip end is disposed. A proximal section of this pin is formed in a flange shape in order to provide the pin from slipping out from the cylindrical section. A resilient force of the spring 305c is applied to the proximal section of this pin, and the contact sections 305a and 305b are pushed out by a resilient force to the sleeve 310c side or stopper 310f side and circuit board 306 side, respectively. Therefore, this signal-feeding pin 305 leads out the signal-feeding section 305b, and is reliably brought into contact with the sleeve 310c or stopper 310f of the retractable antenna 310. Similarly, the signal-feeding section 305b is reliably brought into contact with the signal-feeding terminal 306t of the circuit board 306. As a result, the signal can be reliably fed to the retractable antenna 310.

In the above mobile phone 301, as shown in FIG. 17A and FIG. 17B, while the retractable antenna 310 is housed in the casing 302, the signal-feeding section 305b comes into direct contact with the sleeve 310c of the retractable antenna 310. In this manner, the signal is fed from the circuit board 306 to the helical section 310a via the signal-feeding pin 305 and the sleeve 310c of the retractable antenna 310.

On the other hand, as shown in FIG. 18A and FIG. 18B, while the retractable antenna 310 is extended from the casing 302, the signal-feeding section 305b of the signal-feeding pin 305 comes into direct contact with the stopper 310f of the retractable antenna 310. In this manner, the signal is fed from the circuit board 306 to the antenna element 310d via tile signal-feeding pin 305 and the stopper 310f.

In the mobile phone 301 according to the above fourth embodiment, the signal-feeding member is composed of the signal-feeding pin 305. Thus, the signal can be fed from the antenna sleeve 310c and stopper 310f of the retractable antenna 310 to the signal-feeding terminal 306t of the circuit board 306 with the shortest distance. Thus, a signal feeding distance is the shortest, and an inductor component can be reduced. Thus, the degradation of efficiency hardly occurs. With an effect caused by the antenna holder 303 and the fixing nut 304 being formed of a non-metal material such as a resin, the predetermined performance of transmission characteristics or the like in the retractable antenna 310 can be achieved, and a disturbance of directivity of the retractable antenna 310 hardly occurs.

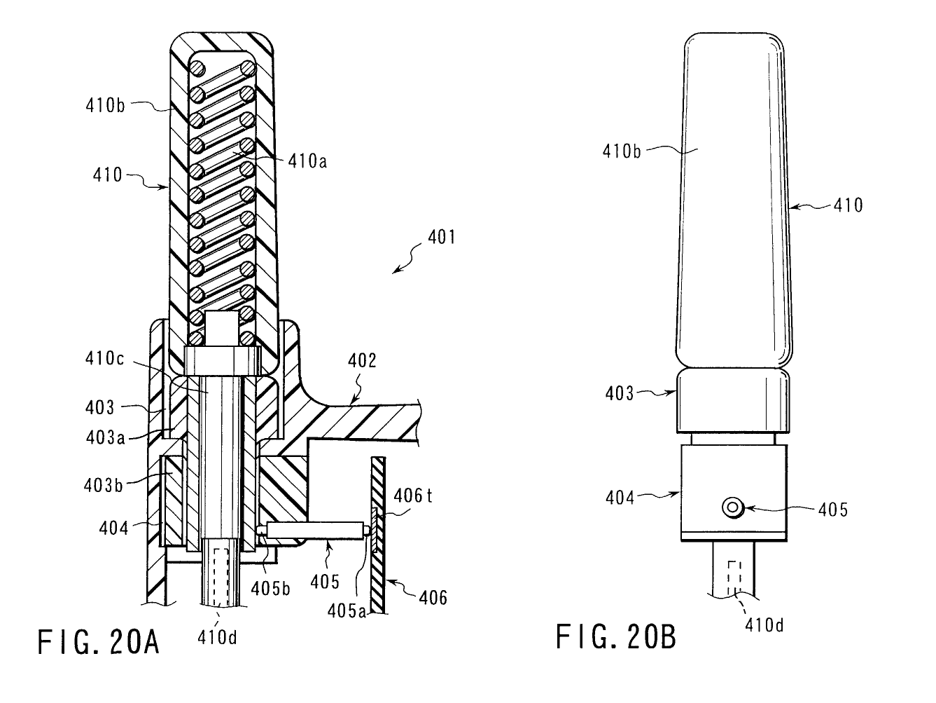

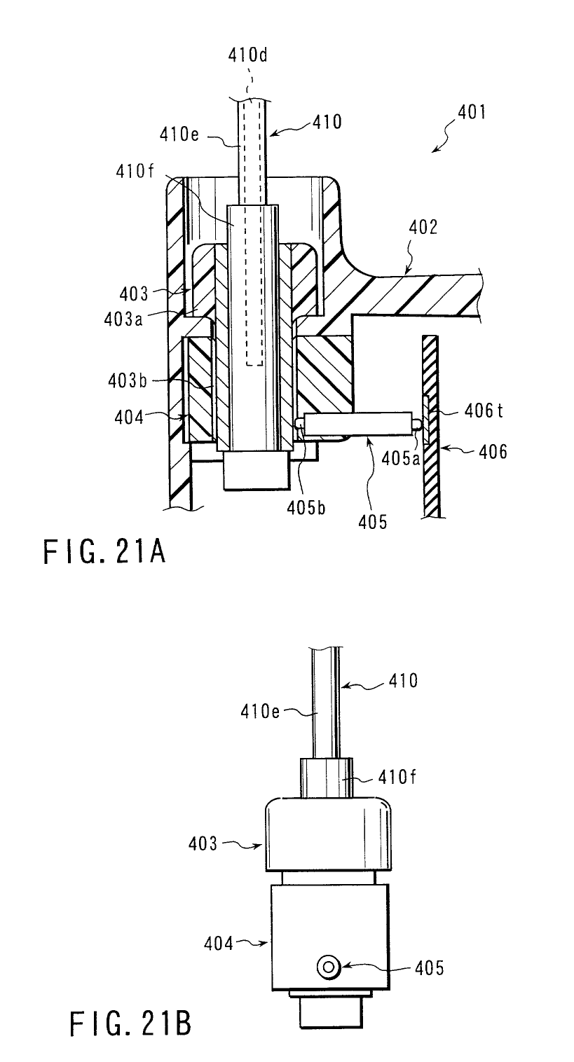

FIG. 20A to FIG. 21B each show a fifth embodiment when the present invention is applied to a mobile phone. FIG. 20A is an enlarged view showing this antenna structure in a partially breakaway manner, the figure showing a state in which a retractable antenna 410 is housed in a casing 402. FIG. 20B is a side view of an antenna structure when a signal-feeding pin 405 shown in FIG. 21A is oriented to a front face. FIG. 21A is an enlarged view showing an antenna structure in a partially breakaway manner, the figure showing a state in which the retractable antenna 410 is extended from the casing 402. FIG. 21B is a side view showing an antenna structure when the signal-feeding pin 405 shown in FIG. 21A is oriented to a front face.

With respect to a description of a mobile phone according to the fifth embodiment, a description of elements and structure identical to those of the mobile phone according to the first embodiment are eliminated. A different structure thereof will be described in more detail.

In the antenna structure according to the fifth embodiment, an antenna holder 403 is formed of a cylindrical non-metal material section 403a at its upper periphery part, and is formed of a cylindrical metal material section 403b therein. A fixing nut 404 holding the antenna holder 403 is formed of a non-metal material such as a resin.

As in the fourth embodiment, a linearly shaped signal-feeding pin 405 is pressed into the fixing nut 404, and a bellows section thereof is fixed to be embedded in the fixing nut 404. The signal-feeding pin 405 has a contact section 405b protruded in a gap between a metal section 403b of the antenna holder and the fixing nut 404, the contact section 405b at one end coming into direct contact with the metal section 403b of the antenna holder. This signal-feeding pin 405 has a contact section 405a protruded toward a signal-feeding terminal 406t on a circuit board 406, the contact section 405a at the other end being brought into contact with the metal section 403b of the antenna holder and the signal-feeding terminal 406t on the circuit board 406, respectively. The contact sections 405a and 405b are slidably provided along its axis so as to come into contact with the metal section 403b of the antenna holder and the signal-feeding terminal 406t of the circuit board 406, respectively.

The fixing nut 404 is tightened with the antenna holder 403 holding the antenna 410. Therefore, the signal-feeding pin 405 pressed in the fixing nut 404 comes into direct contact with the metal section 403b of the antenna holder 403. This pin is precisely positioned at a predetermined location relevant to the retractable antenna 410 via the metal section 403b, i.e., in such a manner that the sleeve 410c and stopper 410f of the retractable antenna 410 come into direct contact with each other.

In the above mobile phone 401, while the retractable antenna 410 shown in FIG. 21A and FIG. 21B is housed in the casing 402, the sleeve 410c is engaged with the antenna holder 403, whereby the signal-feeding pin 405 coming into contact with the signal-feeding terminal 406t on the circuit board 406 is directly connected to the metal section 403b of the antenna holder 403. Therefore, signal is fed from the circuit board 406 to the helical section 410a via the antenna holder 403 and the sleeve 410c of the retractable antenna 410.

On the other hand, while the retractable antenna 410 shown in FIG. 21A and FIG. 21B is extended from the casing 402, the stopper 410f is engaged with the antenna stopper 403. In this manner, the signal-feeding pin 405 coming into contact with the signal-feeding terminal 406t on the circuit board 406 is directly connected to the metal section 403b of the antenna holder 403. Therefore, signal is fed from the circuit board 406 to the antenna element 410d via the signal-feeding pin 405, the antenna holder 403, and the stopper 410f.

In the mobile phone 401 according to the above fifth embodiment, only the inside of the antenna holder 403 is provided as the metal section 403b, and thus, a member with its large capacity consisting of a metal material can be reduced in the signal feeding path. Thus, a change in impedance caused by interposition of a metal material is restricted, and a transmission loss in the retractable antenna 410 is eliminated. Therefore, the predetermined performance such as transmission characteristic in the retractable antenna 410 can be achieved without requiring complicated adjustment work.

In addition, a signal-feeding member is composed of the signal-feeding pin 405. Thus, signal can be fed from the antenna sleeve 410c and stopper 410f to the signal-feeding terminal 406t on the circuit board 406 with the shortest distance. Therefore, an inductor component is reduced, and thus, the degradation of efficiency hardly occurs. With an effect caused by the antenna holder 403 and fixing nut 404 being formed of a non-metal material such as a resin to the maximum, the predetermined performance such as transmission characteristic in the retractable antenna 410 can be achieved. In addition, a disturbance of directivity of the retractable antenna 410 hardly occurs.

In the fifth embodiment, all of the antenna holder 403 may be formed of a metal material within the range in which a change in impedance matching caused by imposition of a metal material of the antenna holder 403 is permitted.

The holder fitting 404 is still formed of a non-metal material, and thus, a member with its large capacity consisting of a metal material can be reduced in the signal-feeding path. Thus, a change in impedance matching caused by interposition of the metal material is restricted, and a transmission loss in the retractable antenna 410 is eliminated. The predetermined performance such as transmission characteristic in the retractable antenna 410 can be achieved without requiring complicated adjustment work.

In addition, the signal-feeding member is composed of the signal-feeding pin 405. Thus, the signal can be fed from the antenna sleeve 410c and stopper 410f to the signal-feeding terminal 406t on the circuit board 406 with the shortest distance. Thus, an inductor component can be reduced, and the degradation of efficiency hardly occurs. With an effect caused by the previously described fixing nut 404 being formed of a resin that is a non-metal material, the predetermined performance such as transmission characteristic in the retractable antenna 410 can be achieved. In addition, a disturbance in directivity of the retractable antenna 410 hardly occurs.

FIG. 22 and FIG. 23 each show a sixth embodiment when the present invention is applied to a signal-feeding device in a mobile phone.

A signal-feeding device 220 shown in FIG. 22 corresponds to that in the third embodiment shown in FIG. 12A to FIG. 16. This signal-feeding device comprises a holder fitting 204 formed of a non-metal material and a signal-feeding pin, i.e., a signal-feeding member 205.

A signal-feeding device 320 shown in FIG. 22 corresponds to that in the third embodiment shown in FIG. 17A to FIG. 19. This signal-feeding device comprises a holder fitting 304 formed of a non-metal material and a signal-feeding pin 305.

Although not shown, it is obvious that a similar signal-feeding device is present in the first embodiment shown in FIG. 3 to FIG. 7, the second embodiment shown in FIG. 8A to FIG. 11, and the fifth embodiment shown in FIG. 20A to FIG. 21B.

In this manner, according to the present invention, the predetermined performance such as antenna transmission characteristic can be achieved without requiring complicated adjustment work. In addition, the stable antenna characteristics can be achieved. Further, weight reduction can be achieved.

In the above embodiments each, although there is shown embodiments in which the present invention is applied to a mobile phone, of course, the present invention can be efficiently applied in a variety of mobile terminal devices other than a mobile phone, such as PHS terminal or PDA comprising a communication function, for example.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile terminal device provide with a circuit board including a signal-feeding circuit for feeding a radio frequency signal, comprising:
a housing configured to receive the circuit board;
an antenna;
an antenna holder configured to hold the antenna, which is formed of a non-metal material;
a holder fitting configured to support the antenna holder, which is formed of a non-metal material and is fixed on the housing, the antenna holder being attached to the holder fitting; and
a signal-feeding member configured to feed the signal to the antenna from the circuit board, the signal-feeding member being supported by the holder fitting.

2. A mobile terminal device according to claim 1, wherein the signal-feeding member has a coupling section configured to capacitively couple to the antenna.

3. A mobile terminal device according to claim 1, wherein the signal-feeding member has a coupling contacted to the antenna.

4. A mobile terminal device according to claim 1, wherein the signal-feeding member has a first coupling pin urged to be electrically and mechanically contacted to the antenna.

5. A mobile terminal device according to claim 1, wherein the signal-feeding member has a second coupling pin urged to be electrically and mechanically contacted to the circuit board.

6. A mobile terminal device according to claim 1, wherein the signal-feeding member has a spring structure urged to be electrically and mechanically contacted to the circuit board.

7. A mobile terminal device provide with a circuit board including a signal-feeding circuit for feeding a radio frequency signal, comprising:
a housing configured to receive the circuit board;
an antenna;
an antenna holder configured to hold the antenna, which includes an outer section formed of a non-metal material and an inner section coaxially arranged in the outer section and formed of an electrical conductive metal member;
a holder fitting configured to support the antenna holder, which is formed of a non-metal material and is fixed on the housing, the antenna holder being attached to the holder fitting; and
a signal-feeding member configured to feed the signal to the antenna from the circuit board, the signal-feeding member being supported by the holder fitting and contacted to the circuit board.

8. A mobile terminal device according to claim 7, wherein the signal-feeding member has a coupling section configured to capacitively electrically couple to the inner section of the antenna holder.

9. A mobile terminal device according to claim 7, wherein the signal-feeding member has a coupling section contacted to the inner section of the antenna holder.

10. A mobile terminal device according to claim 7, wherein the signal-feeding member has a first coupling pin urged to be contacted to the inner section of the antenna holder.

11. A mobile terminal device according to claim 7, wherein the signal-feeding member has a second coupling pin urged to be contacted to the circuit board.

12. A mobile terminal device according to claim 7, wherein the signal-feeding member has a spring structure urged to be contacted to the circuit board.

13. A signal feeding structure for a mobile terminal device having a housing for receiving a circuit board provided with a signal-feeding circuit for generating a radio frequency signal, the signal feeding structure electrically couples the signal feeding circuit of the circuit board to an antenna supported on a antenna holder, the signal feeding structure comprising:
a holder fitting formed of a non-metal material, configured to mount the antenna holder on the housing of the mobile terminal device; and
a signal-feeding member configured to supply the radio frequency signal from the printed circuit board to the antenna, the signal-feeding member being supported on the holder fitting and including a pin which is elastically urged to be contacted to the circuit board and is electrically connected to the signal-feeding circuit.
